(19) United States
(12) Patent Application Publication
(10) Pub. No.: US 2026/0175923 A1
(43) Pub. Date: Jun. 25, 2026

(54) FRONT BODY STRUCTURE

(71) Applicants: Hyundai Motor Company, Seoul (KR); Kia Corporation, Seoul (KR)

(72) Inventors: Sun Ki Choi, Hwaseong-si (KR); Jae Wook Park, Hwaseong-si (KR); Soo Kyung Han, Hwaseong-si (KR)

(21) Appl. No.: 19/306,556

(22) Filed: Aug. 21, 2025

(30) Foreign Application Priority Data
Dec. 20, 2024 (KR) 10-2024-0193137

(51) Int. Cl. B62D 25/14; B62D 25/08

(52) U.S. Cl. CPC B62D 25/14; B62D 25/081; B62D 25/082

(57) ABSTRACT

In certain examples, a front vehicle body structure includes a dash panel, a cowl portion connected to an upper part of the dash panel, a dash lower tunnel portion connected to a lower part of the dash panel, and a dash reinforcing portion mounted at a front part of the dash panel and connecting the cowl portion and the dash lower tunnel portion.

### CROSS-REFERENCE TO RELATED APPLICATIONS

This application claims priority to and the benefit of Korean Patent Application No. 10-2024-0193137 filed with the Korean Intellectual Property Office on Dec. 20, 2024, the entire contents of which are incorporated herein by reference.

### TECHNICAL FIELD

The present invention relates to a front vehicle body structure, and more particularly, the present disclosure relates to a front vehicle body structure having increased strength by improving connectivity between parts.

### BACKGROUND

The cowl and dash panel, which are usually installed at the front of the vehicle body, are connected via a flange.

That is, the dash panel is a structure that supports the cowl with a flange, and the load of the windshield must be completely absorbed by the cowl. Accordingly, the frame strength may not be sufficient, and the booming performance of the windshield may be disadvantageous.

Additionally, the dash cross member mounted on the lower part of the dash panel is connected with a simple flange, requiring reinforcement for the skeletal strength of the front of the vehicle body and the torsional strength of the engine room.

The information contained in this background section is intended to promote understanding of the background of the invention and may include matters that are not conventional art already known to a person of ordinary skill in the field to which this technology belongs.

### SUMMARY

The present disclosure attempts to provide a front vehicle body structure with improved skeletal strength and Noise, Vibration, and Harshness (NVH) performance by securing connectivity at the front of the vehicle body.

A front vehicle body structure according to disclosed embodiments may include a dash panel, a cowl portion connected to an upper part of the dash panel, a dash lower tunnel portion connected to a lower part of the dash panel, and a dash reinforcing portion mounted at a front part of the dash panel and connecting the cowl portion and the dash lower tunnel portion.

The cowl portion, the dash panel, the dash reinforcing portion and the dash lower tunnel portion may form an integrated closed space connected in the vertical direction of the vehicle body.

The dash reinforcing portion may include a reinforcing portion flange connected to the dash panel, the cowl portion, and the dash lower tunnel portion, and a reinforcing portion body protruding from the reinforcing portion flange to form a reinforcing portion closed space.

The dash reinforcing portion may be integrally formed.

The dash reinforcing portion may include a dash main reinforcing portion connected to at least two of the dash panel, the cowl portion, and the dash lower tunnel portion, and a dash bracket connected to the dash main reinforcing portion.

The dash reinforcing portion may be arranged in two or more pieces spaced apart from each other at the front of the dash panel.

The cowl portion, the dash lower tunnel portion and the dash reinforcing portion may be combined in a ladder shape.

The cowl portion may include a cowl front panel, and a cowl rear panel forming a cowl closed space together with the cowl front panel.

The dash lower tunnel portion may form a dash lower closed space together with the dash panel.

The dash lower tunnel portion may include a tunnel upper part forming a dash lower closed space together with the dash panel, and a tunnel lower part connected to the tunnel upper part.

The dash lower tunnel portion may include a dash tunnel reinforcing portion mounted on an inner side thereof.

The front vehicle body structure according to disclosed embodiments may further include a fender apron side member connected to the front of the dash lower tunnel portion.

The dash lower tunnel portion may connect side inners on both sides of the vehicle body.

The dash lower tunnel portion may include a dash lower tunnel main body connected to the fender apron side member, and a dash lower tunnel side connecting the dash lower tunnel main body and the side inner.

The dash lower tunnel portion may further include a dash tunnel reinforcing portion provided on the inner side thereof to transfer the load of the fender apron side member to the rear of the vehicle body.

The front vehicle body structure according to disclosed embodiments may further include a floor member mounted in a corresponding position to the fender apron side member at the rear of the dash panel.

A cowl closed space may be formed in the width direction of the vehicle body on the inner side of the cowl portion, a dash lower closed space may be formed in the width direction of the vehicle body on the inner side of the dash lower tunnel portion, and a closed space may be formed on the inside of the dash reinforcing portion, and the cowl closed space, the dash lower closed space, and the reinforcing portion closed space may be connected to form an integrated closed space.

According to a front vehicle body structure according to embodiments, the performance of frame strength and NVH may be improved by securing connectivity between front parts of the vehicle body.

In addition, any effects that can be obtained or expected due to embodiments are directly or implicitly disclosed in the detailed description of an embodiment. That is, the various effects predicted depending on the embodiments will be disclosed in the detailed description that follows.

### BRIEF DESCRIPTION OF THE DRAWINGS

These drawings are intended for reference in explaining exemplary embodiments of the present invention, and therefore, the technical ideas of the present invention should not be construed as being limited to the accompanying drawings.

FIG. 1 is a perspective view of a front vehicle body structure according to disclosed embodiment.

FIG. 2 is a partial exploded perspective view of a front vehicle body structure according to disclosed embodiment.

FIG. 3 is a perspective view of a modified dash reinforcing portion applicable to a front vehicle body structure according to disclosed embodiment of the present invention.

FIG. 4 is a perspective view of a modified dash lower tunnel portion applicable to a front vehicle body structure according to disclosed embodiment of the present invention.

FIG. 5 is a cross-sectional view of a front vehicle body structure according to disclosed embodiment along line A-A of FIG. 1.

FIG. 6 is a cross-sectional view of a front vehicle body structure according to disclosed modified embodiment of the present invention along line A-A of FIG. 1.

FIG. 7 is a cross-sectional view illustrating the load transfer of the front vehicle body structure according to disclosed embodiment.

FIG. 8 is a perspective view illustrating the load transfer of the front vehicle body structure according to disclosed embodiment.

FIG. 9 is a perspective view from the rear of the front vehicle body structure according to disclosed embodiment.

### DESCRIPTION OF SYMBOLS

10: front vehicle body structure
20: dash panel
30: cowl portion
32: cowl front panel
34: cowl rear panel
36: cowl closed space
50, 51: dash lower tunnel portion
52: tunnel upper part
54: tunnel lower part
56: dash lower closed space
58: dash tunnel reinforcing portion
60: dash lower tunnel main body
62: dash lower tunnel side
64, 66: tunnel flange
70, 71; dash reinforcing portion
72: reinforcing portion flange
74: reinforcing portion body
76: reinforcing portion closed space
80: dash main reinforcing portion
82: dash bracket
90: fender apron side member
110: floor
112: floor member
113: center floor member
120: integrated closed space
130: side inner
140; windshield glass

The drawings referenced above are not necessarily to scale, but should be understood as presenting rather simplified representations of various features illustrating at least some basic principles of the present invention. For example, certain design features of the present invention, including particular dimensions, direction, position, and shape, will be determined in part by the particular intended application and usage environment.

### Detailed Description of Illustrative Embodiments

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

In order to clearly explain the present invention, parts irrelevant to the description are omitted, and the same reference numerals are used for identical or similar components throughout the specification.

The size and thickness of each component shown in the drawing are arbitrarily shown for better understanding and ease of description, so the present invention is not necessarily limited to what is shown in the drawing, and the thickness is shown enlarged to clearly express various parts and regions.

The terminology used herein is for the purpose of describing particular embodiments only and is not intended to limit the present disclosure. As used herein, the singular forms are intended to include the plural forms as well, unless the context clearly indicates otherwise.

Throughout the specification, when a part is said to include a component, this does not mean that other components are excluded, but rather that other components may be included, unless otherwise specifically stated.

Additionally, terms such as “means”, “part”, “unit”, etc., described in the specification mean a comprehensive unit that performs at least one function or operation.

When we say that a part, such as a layer, membrane, region, or plate, is “on top of” another part, this includes not only cases where it is directly on top of the other part, but also cases where there are other parts in between.

In contrast, when an element is referred to as being “directly on” another element, there are no intervening elements present.

It should also be understood that the terms “including” and/or “comprising” as used in this specification indicate the presence of stated features, integers, steps, operations, elements and/or components, but do not preclude the presence or addition of one or more other features, integers, steps, operations, components, and/or groups thereof.

As used in this specification, the term ‘and/or’ includes any one or all combinations of one or more of the associated listed items.

In this specification, the term ‘connected’ indicates a physical relationship between two components where the components are directly connected to each other by welding, rivet, SPR (Self Piercing Rivet), FDS (Flow Drill Screw), structural adhesive, etc., or indirectly connected through one or more intermediate components.

The terms “vehicle”, “car”, “vehicle of”, “vehicular” or other similar terms used in this specification include vehicles including sports utility vehicles (SUVs), buses, trucks, passenger vehicles including various commercial vehicles, ships including various types of boats and vessels, aircraft and the like, as well as hybrid vehicles, electric vehicles, plug-in hybrid electric vehicles, hydrogen fuel vehicles and other alternative fuel (e.g., fuel obtained from resources other than petroleum) vehicles.

In this specification, the reference direction for describing the components below may be set as the vehicle body front-back direction (e.g., vehicle body length direction or longitudinal direction), vehicle width direction (e.g., left-right direction or lateral direction), and vertical direction (e.g., height direction) with the vehicle body as reference.

Embodiments will hereinafter be described in detail with reference to the accompanying drawings.

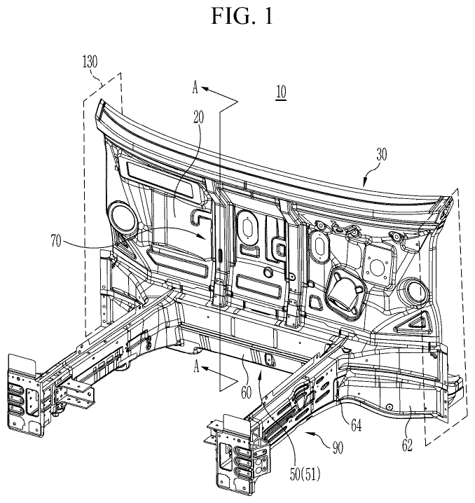

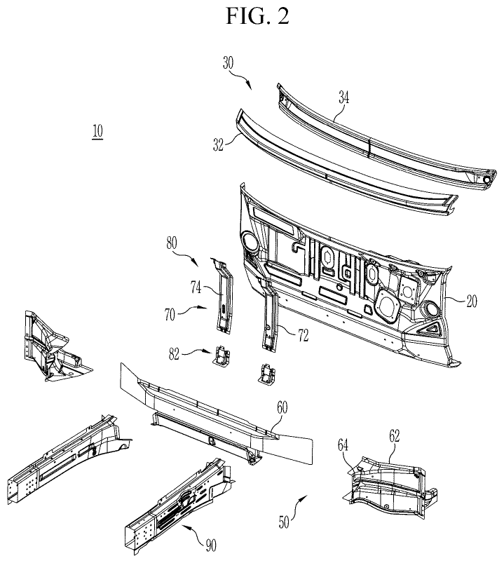

FIG. 1 is a perspective view of a front vehicle body structure according to disclosed embodiment, and FIG. 2 is a partial exploded perspective view of a front vehicle body structure according to disclosed embodiment.

Referring to FIG. 1 and FIG. 2, a front vehicle body structure 10 according to disclosed embodiment may include a dash panel 20, a cowl portion 30 connected to an upper part of the dash panel 20, a dash lower tunnel portion 50 connected to a lower part of the dash panel 20, and a dash reinforcing portion 70 mounted at a front part of the dash panel 20 and connecting the cowl portion 30 and the dash lower tunnel portion 50.

The dash reinforcing portion 70 may improve the frame strength and NVH performance of the front of the vehicle body by connecting the dash panel 20, the cowl portion 30 connected to the dash panel 20, and the dash lower tunnel portion 50.

The front vehicle body structure 10 according to disclosed embodiment may further include a fender apron side member 90 connected to the front of the dash lower tunnel portion 50;

The dash lower tunnel portion 50 supports the fender apron side member 90 so that the load transmitted from the fender apron side member 90 may be transmitted to the rear of the vehicle body through the dash panel 20.

The dash reinforcing portion 70 is connected to the dash lower tunnel portion 50 so that the load transmitted from the fender apron side member 90 may be dispersed.

The dash lower tunnel portion 50 may connect side inners 130 on both sides of the vehicle body.

The dash lower tunnel portion 50 is connected to the side inner 130 so that the load transmitted from the fender apron side member 90 may be dispersed to the rear of the vehicle body through the side inner 130.

The dash reinforcing portion 70 may be arranged as two or more dash reinforcing portions that are spaced apart from each other in front of the dash panel 20.

The cowl portion 30, the dash lower tunnel portion 50, and the dash reinforcing portion 70 may be connected in a ladder shape.

For example, as shown in the drawing, the dash reinforcing portion 70 may be arranged in pairs in front of the dash panel 20.

Through this, the cowl portion 30, the dash lower tunnel portion 50, and the dash reinforcing portion 70 are arranged in an “H” shape overlapping each other to improve the bond strength and strength for the roll.

The drawing shows the dash reinforcing portion 70 as a pair of dash reinforcing portions arranged in front of the dash panel 20, but it is not limited to this configuration, and a configuration in which three or more dash reinforcing portions are arranged in parallel is also possible.

The dash reinforcing portion 70 may include a dash main reinforcing portion 80 connected to at least two of the dash panel 20, the cowl portion 30, and the dash lower tunnel portion 50, and a dash bracket 82 connected to the dash main reinforcing portion 80.

That is, as shown in the drawing, the dash main reinforcing portion 80 may be connected to the dash panel 20 and the cowl portion 30, and the dash bracket 82 may be connected to the dash lower tunnel portion 50.

The dash reinforcing portion 70 is formed separately into the dash main reinforcing portion 80 and the dash bracket 82, thereby increasing the degree of design freedom for material and thickness in response to the performance required for each region.

Although the drawing illustrates that the dash main reinforcing portion 80 is connected to the dash panel 20 and the cowl portion 30, and that the dash bracket 82 is connected to the dash lower tunnel portion 50, it is not limited thereto, and the dash main reinforcing portion 80 may be formed in a shape in which it is connected to the dash panel 20 and the dash lower tunnel portion 50, and the dash bracket 82 may be connected to the cowl portion 30.

The dash lower tunnel portion 50 may include a dash lower tunnel main body 60 connected to the fender apron side member 90 and a dash lower tunnel side 62 connecting the dash lower tunnel main body 60 and the side inner 130.

The dash lower tunnel portion 50 is formed separately into the dash lower tunnel main body 60 and the dash lower tunnel side 62, thereby increasing the degree of design freedom for material and thickness in response to the performance required for each region.

The dash lower tunnel portion 50 may include a tunnel flange 64 that surrounds at least a portion of the fender apron side member 90.

The tunnel flange 64 wraps around the fender apron side member 90 and reinforces the connection between the dash lower tunnel portion 50 and the fender apron side member 90, and allows the load transmitted from the fender apron side member 90 to be dispersed through the dash lower tunnel portion 50 and the side inner 130.

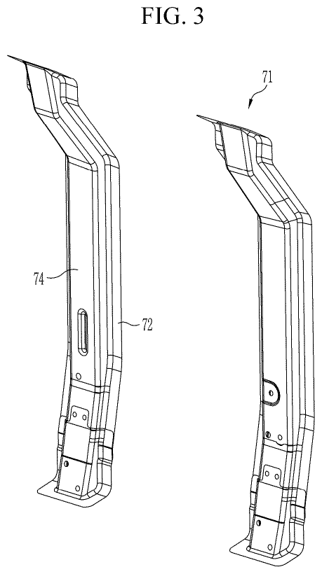

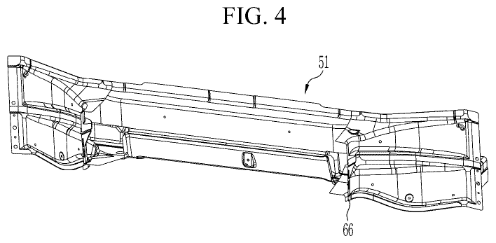

FIG. 3 is a perspective view of a modified dash reinforcing portion applicable to a front vehicle body structure according to disclosed embodiment of the present invention, and FIG. 4 is a perspective view of a modified dash lower tunnel portion applicable to a front vehicle body structure according to disclosed embodiment of the present invention.

In FIG. 3 and FIG. 4, when explaining the dash reinforcing portion and the dash lower tunnel portion that may be applied to the front vehicle body structure according to disclosed embodiment of the present invention, for the convenience of understanding, a repeated explanation of the same configuration and function as the previously explained dash reinforcing portion and the dash lower tunnel portion is omitted.

Referring to FIG. 3, a dash reinforcing portion 71 applicable to the front vehicle body structure according to the disclosed embodiment of the present invention may be integrally formed.

That is, the dash reinforcing portion 71 may be integrally formed and connected to the dash panel 20, the cowl portion 30, and the dash lower tunnel portion 50. This may reduce the number of parts and the performance spread of the parts.

Referring to FIG. 4, the dash lower tunnel portion 51, which may be applied to the front vehicle body structure according to the disclosed embodiment of the present invention, may be integrally formed.

In certain examples, the dash lower tunnel portion 51 is integrally formed, which reduces the number of parts and the performance spread of the parts. The dash lower tunnel portion 51 may include a tunnel flange 66 that surrounds at least a portion of the fender apron side member 90, thereby reinforcing the connection between the dash lower tunnel portion 51 and the fender apron side member 90 and dispersing the load transferred from the fender apron side member 90 through the dash lower tunnel portion 51 and the side inner 130.

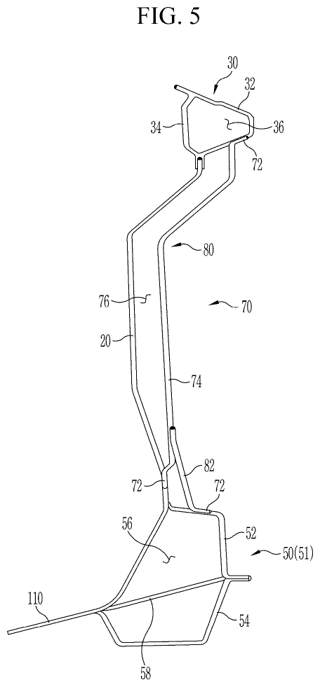

FIG. 5 is a cross-sectional view of a front vehicle body structure according to disclosed embodiment along line A-A of FIG. 1.

Referring to FIG. 1, FIG. 2 and FIG. 5, the dash reinforcing portion 70 may include a reinforcing portion flange 72 connected to the dash panel 20, the cowl portion 30, and the dash lower tunnel portion 50, and may also include a reinforcing portion body 74 protruding from the reinforcing portion flange 72 to form a reinforcing portion closed space 76.

The reinforcing portion closed space 76 is formed between the dash panel 20 and the reinforcing portion body 74 to increase the cross-section coefficient and increase the longitudinal direction strength of the dash panel 20 and/or the height direction strength of the vehicle body.

The cowl portion 30 may include a cowl front panel 32, and a cowl rear panel 34 forming a cowl closed space 36 together with the cowl front panel 32.

The cowl closed space 36 is formed in the transverse direction of the vehicle body, i.e., the width direction, and may increase the strength of the cowl portion 30 and the dash panel 20 in the transverse direction or the width direction of the vehicle body.

As shown in the drawing, the cowl closed space 36 and the reinforcing portion closed space 76 are connected without a disconnection, so that the connection between the dash panel 20 and the cowl portion 30 is strengthened, and NVH performance may be improved.

The dash lower tunnel portion 50 may be connected to the dash panel 20 to form a dash lower closed space 56.

For example, the dash lower tunnel portion 50 may include a tunnel upper part 52 forming the dash lower closed space 56 together with the dash panel 20, and a tunnel lower part 54 connected with the tunnel upper part 52.

The lower closed space 56 is formed in the transverse direction of the vehicle body, i.e., the width direction, and may increase the strength of the dash lower tunnel portion 50 in the transverse direction or the width direction of the vehicle body.

The dash main reinforcing portion 80 is connected to the dash panel 20 via the reinforcing portion flange 72, the lower portion of the dash main reinforcing portion 80 is connected to the dash bracket 82, and the dash bracket 82 may be connected to the dash lower tunnel portion 50.

The dash lower tunnel portion 50 may include a dash tunnel reinforcing portion 58 mounted on inner side thereof.

The dash tunnel reinforcing portion 58 may be provided on the inner side of the dash lower tunnel portion 50 to transfer the load of the fender apron side member 90 to the rear of the vehicle body.

In some examples, the dash tunnel reinforcing portion 58 is mounted inside the lower closed space 56 to increase the cross-section coefficient of the dash lower tunnel portion 50. Additionally, the dash tunnel reinforcing portion 58 may be positioned toward the rear of the dash panel 20, for example, toward the floor 110, to reinforce the connection between parts.

As shown in the drawing, the reinforcing portion closed space 76 and the lower closed space 56 are connected without disconnection, so that the connection between the dash panel 20 and the dash lower tunnel portion 50 is strengthened, and NVH performance may be improved.

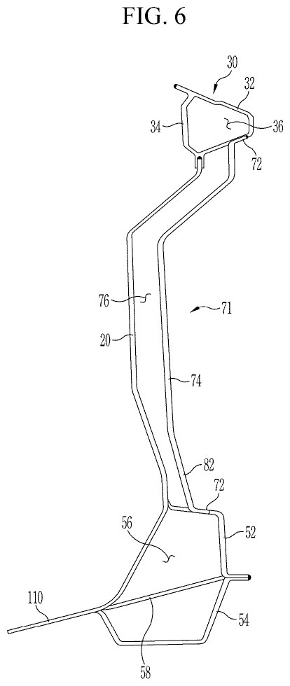

FIG. 6 is a cross-sectional view of a front vehicle body structure according to disclosed modified embodiment of the present invention along line A-A of FIG. 1.

In FIG. 6, when describing the front vehicle body structure according to disclosed modified embodiment of the present invention, for the convenience of understanding, repeated descriptions of the same configuration and function as previously described are omitted.

The dash reinforcing portion 71 may be connected to the dash panel 20 to form the reinforcing portion closed space 76, and may be connected to the dash lower tunnel portion 50 through the reinforcing portion flange 72. For example, the reinforcing portion flange 72 may be connected to the tunnel upper part 52.

As shown in the drawing, the reinforcing portion closed space 76 and the lower closed space 56 are connected without disconnection, so that the connection between the dash panel 20 and the dash lower tunnel portion 50 is strengthened, and NVH performance may be improved.

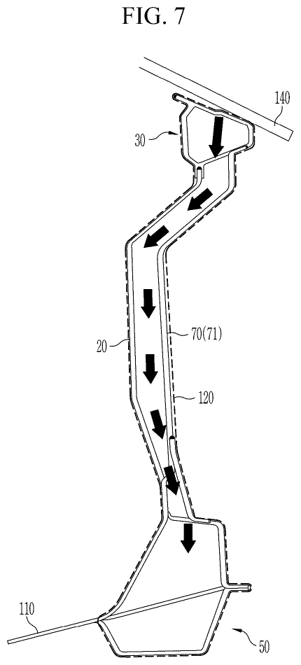

FIG. 7 is a cross-sectional view illustrating the load transfer of the front vehicle body structure according to disclosed embodiment.

Referring to FIG. 5 to FIG. 7, the cowl portion 30, the dash panel 20, the dash reinforcing portion 70 or 71 and the dash lower tunnel portion 50 may form an integrated closed space 120 connected in the vertical direction of the vehicle body.

That is, the cowl closed space 36 is formed in the width direction of the vehicle body on the inner side of the cowl portion 30, the dash lower closed space 56 is formed in the width direction of the vehicle body on the inner side of the dash lower tunnel portion 50, and the reinforcing portion closed space 76 is formed on the inner sides of the dash reinforcing portion 70 or 71, and the cowl closed space 36, the dash lower closed space 56, and the reinforcing portion closed space 76 may be connected to form the integrated closed space 120.

The integrated closed space 120 may firmly support the windshield glass 140 by connecting the dash lower tunnel portion 50 to the windshield glass 140 placed on the upper portion of the cowl portion 30.

This may reduce booming from the windshield glass and improve the vibration characteristics of the steering column.

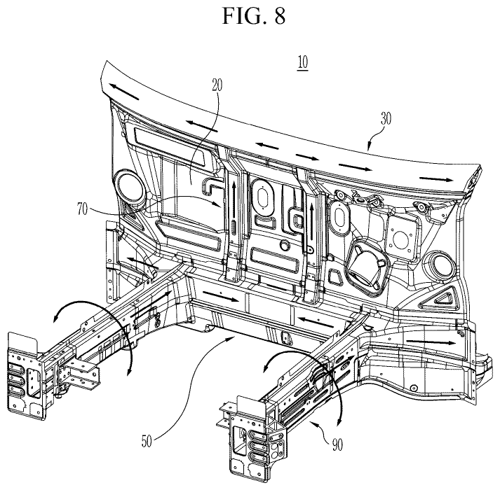

FIG. 8 is a perspective view illustrating the load transfer of the front vehicle body structure according to disclosed embodiment.

As indicated by the arrows in FIG. 8, according to the front vehicle body structure 10 according to disclosed embodiment of the invention, the cowl portion 30, the dash lower tunnel portion 50, and the dash reinforcing portion 70 are combined in a ladder shape to increase the connection between parts and improve the dispersion effect of the load.

The cowl portion 30, the dash lower tunnel portion 50, and the dash reinforcing portion 70 may absorb the load and moment in the front-rear direction of the vehicle body of the fender apron side member 90 and disperse them toward the rear of the vehicle body. This prevents stress concentration in specific areas and strengthens the engine room skeleton.

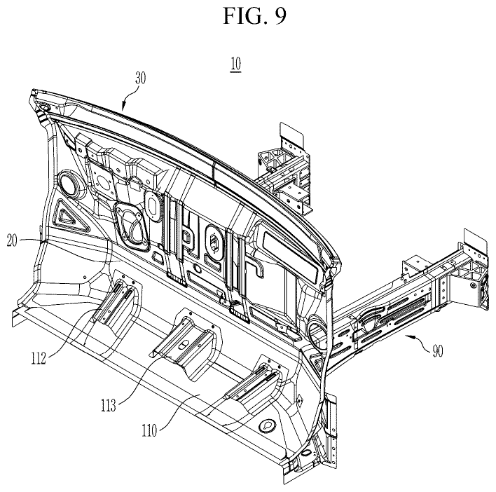

FIG. 9 is a perspective view from the rear of the front vehicle body structure according to disclosed embodiment.

Referring to FIG. 9, the front vehicle body structure 10 according to disclosed embodiment may further include a floor member 112 mounted at a position corresponding to the fender apron side member 90 at the rear of the dash panel 20.

For example, the floor member 112 may be mounted on the floor 110, and the floor member 112 may be mounted at a position corresponding to the fender apron side member 90 so that the load transmitted from the fender apron side member 90 may be dispersed toward the rear of the vehicle body.

A center floor member 113 is mounted between the floor members 112 to increase the strength of the floor 110.

The front vehicle body structure 10 according to disclosed embodiment may improve the performance of frame strength and NVH by securing the connectivity between the front parts of the vehicle body.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A front vehicle body structure comprising:
a dash panel;
a cowl portion connected to an upper part of the dash panel;
a dash lower tunnel portion connected to a lower part of the dash panel; and
a dash reinforcing portion mounted at a front part of the dash panel and connecting the cowl portion and the dash lower tunnel portion.

2. The front vehicle body structure of claim 1, wherein:
the cowl portion, the dash panel, the dash reinforcing portion, and the dash lower tunnel portion form an integrated closed space connected in a vertical direction of a vehicle body.

3. The front vehicle body structure of claim 1, wherein the dash reinforcing portion comprises:
a reinforcing portion flange connected to the dash panel, the cowl portion, and the dash lower tunnel portion; and
a reinforcing portion body protruding from the reinforcing portion flange to form a reinforcing portion closed space.

4. The front vehicle body structure of claim 3, wherein the dash reinforcing portion is integrally formed.

5. The front vehicle body structure of claim 3, wherein the dash reinforcing portion comprises:
a dash main reinforcing portion connected to at least two of the dash panel, the cowl portion, and the dash lower tunnel portion; and
a dash bracket connected to the dash main reinforcing portion.

6. The front vehicle body structure of claim 1, wherein the dash reinforcing portion is arranged in two or more pieces spaced apart from each other at a front of the dash panel.

7. The front vehicle body structure of claim 6, wherein the cowl portion, the dash lower tunnel portion, and the dash reinforcing portion are combined in a ladder shape.

8. The front vehicle body structure of claim 1, wherein the cowl portion comprises:
a cowl front panel; and
a cowl rear panel forming a cowl closed space together with the cowl front panel.

9. The front vehicle body structure of claim 1, wherein the dash lower tunnel portion forms a dash lower closed space together with the dash panel.

10. The front vehicle body structure of claim 1, wherein the dash lower tunnel portion comprises:
a tunnel upper part forming a dash lower closed space together with the dash panel; and
a tunnel lower part connected to the tunnel upper part.

11. The front vehicle body structure of claim 10, wherein the dash lower tunnel portion comprises a dash tunnel reinforcing portion mounted on an inner side thereof.

12. The front vehicle body structure of claim 1, further comprising a fender apron side member connected to a front of the dash lower tunnel portion.

13. The front vehicle body structure of claim 12, wherein the dash lower tunnel portion connects side inners on both sides of the vehicle body.

14. The front vehicle body structure of claim 13, wherein the dash lower tunnel portion comprises:
a dash lower tunnel main body connected to the fender apron side member; and
a dash lower tunnel side connecting the dash lower tunnel main body and a side inner of the side inners.

15. The front vehicle body structure of claim 12, wherein the dash lower tunnel portion further comprises a dash tunnel reinforcing portion provided on an inner side thereof to transfer a load of the fender apron side member to a rear of the vehicle body.

16. The front vehicle body structure of claim 12, further comprising a floor member mounted in a corresponding position to the fender apron side member at a rear of the dash panel.

17. The front vehicle body structure of claim 1, wherein:
a cowl closed space is formed in a width direction of a vehicle body on an inner side of the cowl portion;
a dash lower closed space is formed in the width direction of the vehicle body on an inner side of the dash lower tunnel portion; and
a reinforcing portion closed space is formed on an inside of the dash reinforcing portion; and
the cowl closed space, the dash lower closed space, and the reinforcing portion closed space are connected to form an integrated closed space.

18. A front vehicle body structure comprising:
a dash panel;
a cowl portion connected to an upper part of the dash panel;
a dash lower tunnel portion connected to a lower part of the dash panel;
a first dash reinforcing portion mounted at a front part of the dash panel and connecting the cowl portion and the dash lower tunnel portion; and
a second dash reinforcing portion mounted at the front part of the dash panel and connecting the cowl portion and the dash lower tunnel portion,
wherein the cowl portion, the dash lower tunnel portion, the first dash reinforcing portion, and the second dash reinforcing portion are combined in a ladder shape.

19. The front vehicle body structure of claim 18, wherein:
a cowl closed space is formed in a width direction of a vehicle body on a cowl portion inner side of the cowl portion,
a dash lower closed space is formed in the width direction of the vehicle body on a dash lower portion inner side of the dash lower tunnel portion,
a first reinforcing portion closed space is formed on a first dash reinforcing portion inside of the first dash reinforcing portion,
the cowl closed space, the dash lower closed space, and the first reinforcing portion closed space are connected to form a first integrated closed space,
a second reinforcing portion closed space is formed on a second dash reinforcing portion inside of the second dash reinforcing portion, and
the cowl closed space, the dash lower closed space, and the second reinforcing portion closed space are connected to form a second integrated closed space.

20. A vehicle body, comprising:
a front vehicle body structure, comprising:
a dash panel;
a cowl portion connected to an upper part of the dash panel;
a dash lower tunnel portion connected to a lower part of the dash panel;
a dash reinforcing portion mounted at a front part of the dash panel and connecting the cowl portion and the dash lower tunnel portion; and
a fender apron side member connected to a front of the dash lower tunnel portion.
